(19) United States
(12) Patent Application Publication
(10) Pub. No.: US 2026/0212545 A1
(43) Pub. Date: Jul. 23, 2026

(54) RGB Frequency Modulated Presentation

(71) Applicant: International Business Machines Corporation, Armonk, NY (US)

(72) Inventors: Wynter Yan Chen, Poughkeepsie, NY (US); James Carignan, Hyde Park, NY (US); James Jenkins, Pleasant Valley, NY (US); Lisander Lopez, Poughkeepsie, NY (US); Selena Richards, Wappingers Falls, NY (US); Arkadiy O. Tsfasman, Wappingers Falls, NY (US)

(21) Appl. No.: 19/034,995

(22) Filed: Jan. 23, 2025

(51) Int. Cl. G06T 11/00; G06F 21/10

(52) U.S. Cl. CPC G06T 11/10; G06F 21/106

(57) ABSTRACT

A method secures a slide. Content in the slide is converted to an image comprising pixels. Each pixel is assigned to one of a first set, a second set, and a third set. Three frames are generated using the first set, the second set, and the third set. A red filter, a green filter, and a blue filter are alternatingly applied to the first set, the second set, and the third set in each of the three frames. A frame rate is set for the three frames. The frame rate enables the three frames for the image to be visible to a human eye. A frame loop comprising the three frames is created with the first set, the second set, and the third set. The slide is saved with the frame loop as the content for the slide.

### BACKGROUND

The disclosure relates generally to an improved computer system and more specifically to securely displaying slides in the computer system.

Video meetings are virtual online meetings that enhance communications between people in various geographic locations without a plan for people to gather in a single location. With video meetings, the materials such as slides can be presented as a tool in enhancing communications at these meetings. These slides can be used to ensure highlighted points are presented and enable understanding of information by the participants to a video meeting. For example, information can be presented using text, images, and multi-media using slides during the video meeting.

With confidential presentations, preventing the capture or recording of these images may be desirable for some or all slides presented during the meeting. In these situations, digital rights management (DRM) software, encrypted media extensions, and other mechanisms can be used to prevent screenshots or recording of slides displayed during a video meeting.

### SUMMARY

According to one illustrative embodiment, a method secures a slide. Content in the slide is converted to an image comprising pixels. Each pixel in the image is assigned to one of a first set, a second set, and a third set. Three frames are generated using the first set, the second set, and the third set in which a red filter, a green filter, and a blue filter are alternatingly applied to the first set, the second set, and the third set in each of the three frames. A frame rate is set for the three frames, wherein the frame rate enables the three frames for the image to be visible to a human eye. A frame loop comprising the three frames is created with the first set, the second set, and the third set. The slide is saved with the frame loop as the content for the slide. According to other illustrative embodiments, a computer system and a computer program product for securing a slide are provided.

### BRIEF DESCRIPTION OF THE DRAWINGS

FIG. 1 is a block diagram of a computing environment in accordance with an

illustrative embodiment;

FIG. 2 is a block diagram of a presentation environment in accordance with an illustrative embodiment;

FIG. 3 is an illustration of pixels assigned to frames in accordance with an illustrative embodiment;

FIG. 4 is a flowchart of a process for securing one or more slides in the presentation in accordance with an illustrative embodiment;

FIG. 5 is a flowchart of a process for securing a slide in accordance with an illustrative embodiment;

FIG. 6 is a flowchart of a process for displaying a slide in accordance with an illustrative embodiment;

FIG. 7 is a flowchart of a process for setting a frame rate in accordance with an illustrative embodiment;

FIG. 8 is a flowchart of a process for assigning pixels to sets in accordance with an illustrative embodiment;

FIG. 9 is a flowchart of a process for assigning pixels to sets in accordance with an illustrative embodiment; and

FIG. 10 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

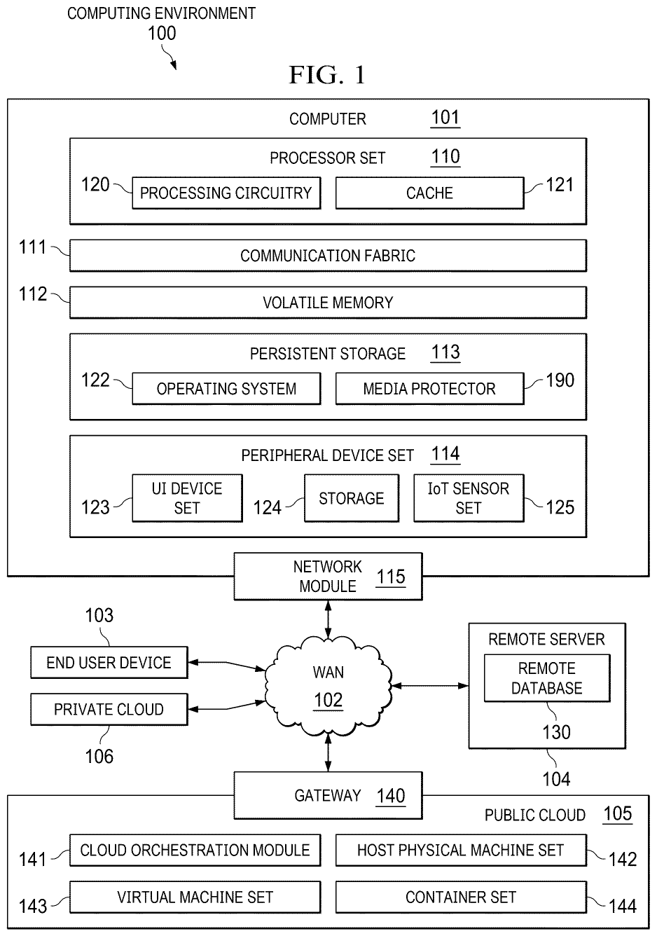

With reference now to the figures in particular with reference to FIG. 1, a block diagram of a computing environment is depicted in accordance with an illustrative embodiment. Computing environment 100 contains an example of an environment for the execution of at least some of the computer code involved in performing the inventive methods, such as media protector 190. In addition to media protector 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and media protector 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in media protector 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in media protector 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, digital rights management (DRM) and encrypted media extensions can be used to prevent screenshots and screen recordings made directly on a computer connected to the meeting. These types of protections, however, do not prevent participants capturing images or recording video displayed on the computer through an external device such as a mobile phone. Further, current systems cannot enable determining whether someone has captured confidential information during the online meeting. Although watermarks can be used, watermarks can be easily edited out of a screenshot or recording. It would be desirable to have a mechanism to secure confidential information in slides such that screen shots, screen recordings, external photos, and external figures cannot be made of the slides containing confidential information.

Thus, the illustrative examples provide a computer method, apparatus, system, and computer program product for securing slides in a presentation. In one illustrative example, red, green, blue (RGB) modulated security can be used to obscure slides in a manner that prevents reproduction of the slides. An RGB modulated security system can prevent the recording of slides by external devices that may capture images for video of a presentation displayed on a display system.

An image on an electronic display is divided by pixels. Each pixel rotates between red, green, and blue values on three separate frames. The red, green, and blue are utilized as they are the three primary colors that comprise a white light emitting diode (LED). The frames can alternate between a minimum frame rate and maximum frame rate. The frame rate is selected such that the human eye can perceive the entire image. Furthermore, the frame rate can dynamically change based on the minimum frame rate and the maximum frame rate resulting in a frequency modulation of the slide.

Thus, illustrative examples provide a method, apparatus, computer system, and program product for securing a slide presentation. In one illustrative example, a method is provided for securing a slide. The content in the slide is converted to an image comprising pixels. Each pixel in the image is assigned to one of a first set, a second set, and a third set. Three frames are generated using the first set, the second set, and the third set in which a red filter, a green filter, and a blue filter are alternatingly applied to the first set, the second set, and the third set in each of the three frames. A frame rate is set for the three frames. The frame rate enables the three frames for the image to be visible to a human eye. A frame loop is created comprising the three frames with the first set, the second set, and the third set. The slide is saved with the frame loop as the content for the slide.

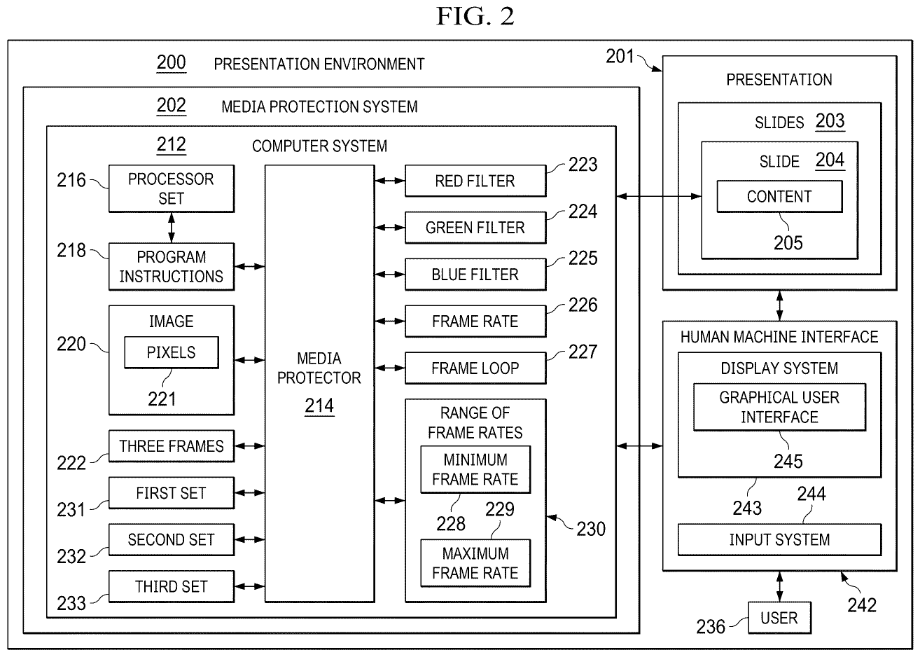

With reference now to FIG. 2, a block diagram of a presentation environment is depicted in accordance with an illustrative embodiment. In this illustrative example, presentation environment 200 includes components that can be implemented in hardware such as the hardware shown in computing environment 100 in FIG. 1. In this example, media protection system 202 can operate to secure one or more of slides 203 in presentation 201. Media protector 214 may be implemented using media protector 190 in FIG. 1.

Media protector 214 can be implemented in software, hardware, firmware or a combination thereof. When software is used, the operations performed by media protector 214 can be implemented in program instructions configured to run on hardware, such as a processor unit. When firmware is used, the operations performed by media protector 214 can be implemented in program instructions and data and stored in persistent memory to run on a processor unit. When hardware is employed, the hardware can include circuits that operate to perform the operations in media protector 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and any number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes processor set 216 that is capable of executing program instructions 218 implementing processes in the illustrative examples. In other words, program instructions 218 are computer-readable program instructions. Processor set 216 is an example of processor set 110 in FIG. 1.

As used herein, a processor unit in processor set 216 is a hardware device and is comprised of hardware circuits such as those on an integrated circuit that respond to and process instructions and program code that operate a computer. Processor set 216 can be a number of processor units that can be implemented using processor set 110 in FIG. 1. The processor units can also be referred to as computer processors. When processor set 216 executes program instructions 218 for a process, processor set 216 can be one or more processor units that are in the same computer or in different computers. In other words, the process can be distributed between processor units in processor set 216 on the same or different computers in computer system 212.

Further, processor set 216 can include the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

Although not shown, processor set 216 can also include other components in addition to the processor units or processing circuitry. For example, processor set 216 can also include a cache or other components used with processor units or other processing circuitry.

In this illustrative example, media protector 214 secures slide 204 in slides 203. In other words, media protector 214 can protect slide 204 against unauthorized or undesired capture by a camera in a device such as a mobile phone, smart watch, or tablet.

Media protector 214 converts content 205 in slide 204 to image 220 comprising pixels 221. In this illustrative example, content 205 can be selected from at least one of text, an image, a graphic, or other visualization.

In this example, media protector 214 assigns each pixel in pixels 221 to one of first set 231, second set 232, and third set 233. In assigning each pixel to these sets, media protector 214 can randomly assign each pixel in pixels 221 to first set 231, second set 232, and third set 233. In another example, media protector 214 can assign pixels 221 to first set 231, second set 232, and third set 233 in response to a user input selecting pixels 221 for first set 231, second set 232, and third set 233. The user input can select groups or regions of pixels 221 that are to be assigned to the different sets. This assignment of pixels 221 results in first set 231 of pixels 221, second set 232 of pixels 221, and third set 233 of pixels 221.

In this illustrative example, media protector 214 generates three frames 222 using first set 231, second set 232, and third set 233. Further, red filter 223, green filter 224, and blue filter 225 are alternatingly applied to first set 231, second set 232, and third set 233 in each of three frames 222.

For example, in the first frame in three frames 222, red filter 223 is applied to first set 231 of pixels 221; green filter 224 is applied to second set 232 of pixels 221; and blue filter 225 is applied to third set 233 of pixels 221. In the second frame in three frames 222, green filter 224 is applied to first set 231 of pixels 221; blue filter 225 is applied to second set 232 of pixels 221; and red filter 223 is applied to third set 233 of pixels 221. Next in the third frame in three frames 222, blue filter 225 is applied to first set 231 of pixels 221; red filter 223 is applied to second set 232 of pixels 221; and green filter 224 is applied to third set 233 of pixels 221.

Further in this example, media protector 214 sets frame rate 226 for three frames 222. In this example, frame rate 226 enables three frames 222 for image 220 to be visible to a human eye. Each frame can have a different frame rate from the other frames, each frame can have a frame rate that changes each time the frame is displayed, the frame loop can have different frame rates, or some combination thereof.

Media protector 214 creates frame loop 227 comprising three frames 222 with first set 231, second set 232, and third set 233. Next, media protector 214 saves slide 204 with frame loop 227 as content 205 for slide 204.

In this illustrative example, frame loop 227 is during a display of slide 204. For example, slide 204 may be displayed along with slides 203 as part of displaying presentation 201. This display can be on human machine interface 242. In this example, slide 204 with frame loop 227 is secured with frequency modulation using frame rate 226 during the display of slide 204 on human machine interface 242.

In this example, human machine interface 242 comprises display system 243 and input system 244. Display system 243 is a physical hardware system and includes one or more display devices on which graphical user interface 245 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

User 236 is a person that can interact with graphical user interface 245 through user input generated by input system 244 for display system 243. Input system 244 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device.

With this example, slide 204 with frame loop 227 as content 205 is displayed within graphical user interface 245. This display is performed using frame rate 226 selected for frame loop 227. For example, frame rate 226 for three frames 222 in frame loop 227 can be comprised of a number of frame rates in range of frame rates 230. These frame rates for the frames can be randomly selected. Each frame can have a different frame rate from the other frames in frame loop 227. Further, each frame can have a frame rate that changes each time the frame is displayed. Thus, the frames can have the same frame rates, different frame rates, or some combination thereof.

In one example, media protector 214 sets frame rate 226 within range of frame rates 230 from minimum frame rate 228 to maximum frame rate 229. With this example, range of frame rates 230 is visible to the human eye.

In another example, frame rate 226 can be the frame rate for both frame loop 227 and frame rate 226 for frame loop 227 and dynamically changes during the display of frame loop 227. For example, frame rate 226 can be the same for the frames in frame loop 227 in which frame rate 226 can change each time frame loop 227 repeats.

In one illustrative example, one or more technical solutions are present that overcome a technical problem with preventing capturing slides containing confidential information and presentations. With the use of filters and the frequency rate, frequency modulation occurs during the display of the slide in a manner that avoids or reduces the chance that the slide will be captured in a photograph or screenshot. Any photograph or screenshot will be heavily pixelated with color distortion. As a result, this type of distortion in a photograph or screenshot indicates that unauthorized copying or imaging of the slide has been performed. In these examples, this process provides a frequency modulated presentation of slides containing information that should not be copied or photographed.

The illustration of presentation environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

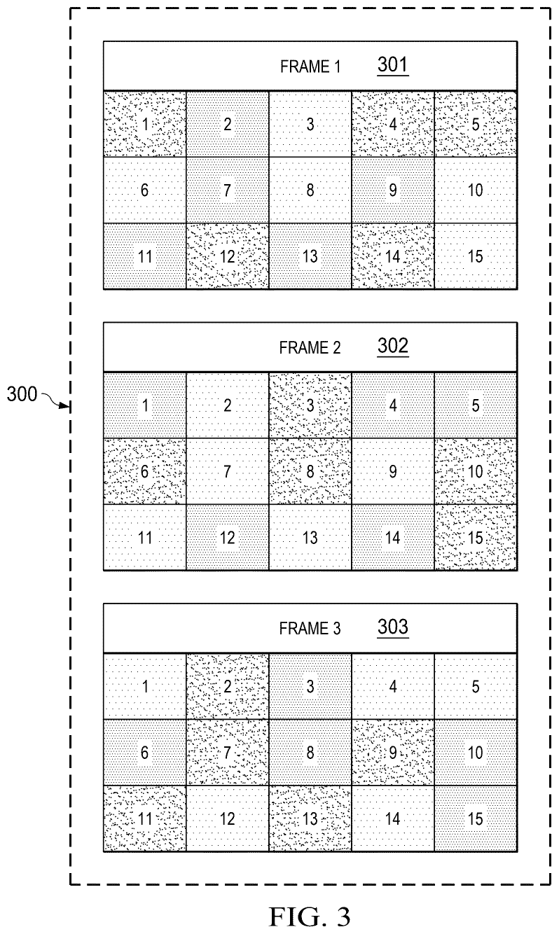

With reference to FIG. 3, an illustration of pixels assigned to frames is depicted in accordance with an illustrative embodiment. In this illustrative example, three frames 300 comprise frame 1 301, frame 2 302, and frame 3 303. These frames are shown with assignments of pixels. These frames are examples of frames in three frames 222 in FIG. 2.

In this example, the pixels from an image are assigned the three sets. For example, the first comprises pixels 1, 4, 5, 12, and 14; the second set comprises pixels 2, 7, 9, 11, and 13; and the third set comprises 3, 6, 8, 10, and 15.

As depicted, a red filter, a green filter, and a blue filter are applied in an alternating manner to the set of pixels between the different frames. In this example, in frame 1 301, a red filter is applied to the first set; a green filter is applied to the second set; and a blue filter is applied to the third set. In frame 2 302, a green filter is applied to the first set; a blue filter is applied to the second set; and a red filter is applied to the third set. Next in frame 3 303, a blue filter is applied to the first set; a red filter is applied to the second set; and a green filter is applied to the third set.

These three frames are used to create a frame loop that can be displayed in a secure manner. The frame loop can be a frame rate that is assigned to each of frames 300 for the loop in which the frame rate can change to provide frequency modulation that prevents or reduces the ability to capture the frames using a camera.

The illustration of frames with pixels is provided as a simplified example to demonstrate the features in the illustrative examples and not meant to limit the manner in which other illustrative examples can be implemented. For example, the image may be 1024 by 768 pixels. With this size image, 786432 pixels are present. Further in this example, each set contains five pixels. In other illustrative examples, the sets can have different numbers of pixels with respect to each other. In other words, the sets may not all have the same number of pixels.

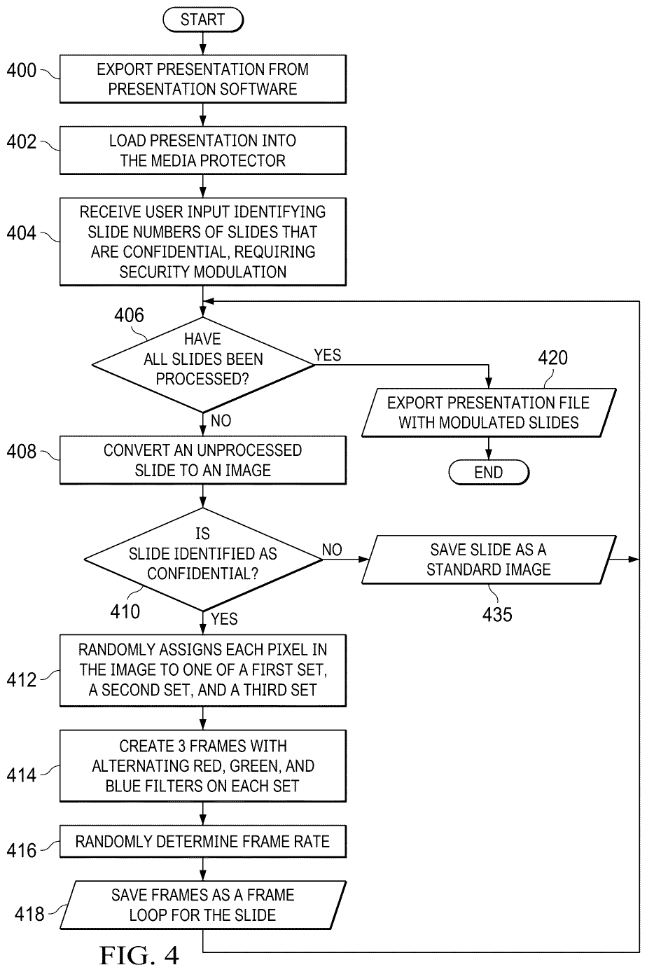

Turning next to FIG. 4, a flowchart of a process for securing one or more slides in the presentation is depicted in accordance with an illustrative embodiment. The process in this flowchart can be implemented in hardware, software, or both. When implemented in software, the process can take the form of program instructions that are run by a processor set located in one or more hardware devices in one or more computer systems. For example, the process can be implemented in media protector 214 in computer system 212 in FIG. 2.

The process begins by exporting a presentation from presentation software (step 400). The process loads the presentation into the media protector (step 402). The process receives user input identifying slide numbers of slides that are confidential, requiring security modulation (step 404).

A determination is made as to whether all the slides have been processed (step 406). If all the slides have not been processed, the process converts an unprocessed slide to an image (step 408). A determination is made as to whether the slide has been identified as being confidential (step 410). If the slide has been identified as confidential, the process randomly assigns each pixel in the image to one of a first set, a second set, and third set (step 412). The process creates three frames with alternating red, green, and blue filters on the set (step 414).

The process randomly determines a frame rate for the frames (step 416). The process saves the frames as a frame loop for the slide (step 418). The process then returns to step 406. In step 406, if all the slides have been processed, the process exports the presentation with modulated slides (step 420). The process terminates thereafter.

Turning back to step 410, if the slide is not identified as confidential, the process saves the slide as a standard image (step 435). In some cases, the determination in step 410 can be performed prior to step 408. In this case, the slide can be saved without any conversions or changes.

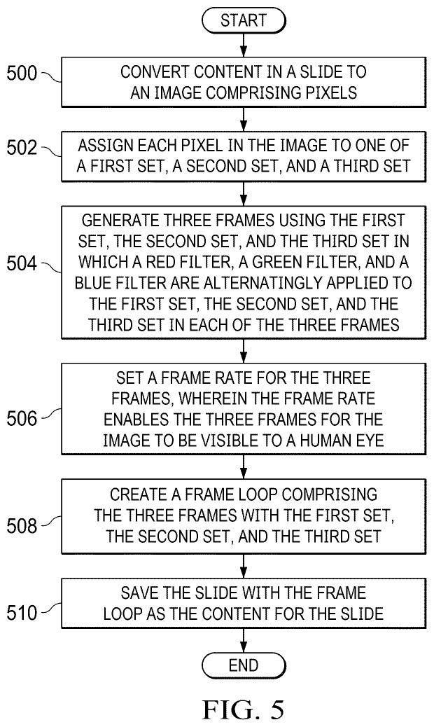

Turning next to FIG. 5, a flowchart of a process for securing a slide is depicted in accordance with an illustrative embodiment. The process in FIG. 5 can be implemented in hardware, software, or both. When implemented in software, the process can take the form of program instructions that are run by a processor set located in one or more hardware devices in one or more computer systems. For example, the process can be implemented in media protector 214 in computer system 212 in FIG. 2.

The process begins by converting content in a slide to an image comprising pixels (step 500). The process assigns each pixel in the image to one of a first set, a second set, and a third set (step 502). The process generates three frames using the first set, the second set, and the third set in which a red filter, a green filter, and a blue filter are alternatingly applied to the first set, the second set, and the third set in each of the three frames (step 504).

The process sets a frame rate for the three frames, wherein the frame rate enables the three frames for the image to be visible to a human eye (step 506). The process creates a frame loop comprising the three frames with the first set, the second set, and the third set (step 508).

The process saves the slide with the frame loop as the content for the slide (step 510). The process terminates thereafter.

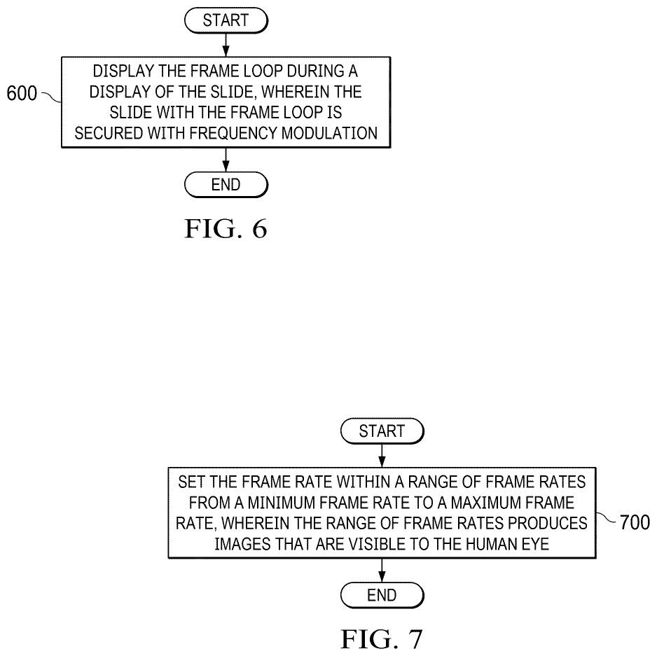

With reference next to FIG. 6, a flowchart of a process for displaying a slide is depicted in accordance with an illustrative embodiment. The process in this flowchart is an additional step that can be performed with the steps in FIG. 5.

The process displays the frame loop during a display of the slide, wherein the slide with the frame loop is secured with frequency modulation (step 600). The process terminates thereafter.

Turning to FIG. 7, a flowchart of a process for setting a frame rate is depicted in accordance with an illustrative embodiment. The process in this figure is an example of an implementation for step 506 in FIG. 5.

The process sets the frame rate within a range of frame rates from a minimum frame rate to a maximum frame rate, wherein the range of frame rates produces images that are visible to the human eye (step 700). The process terminates thereafter.

In step 700, the frame rate can comprise a number of frame rates in the range of frame rates that is randomly selected. In another example, the frame rate is for the frame loop and the frame rate for the frame loop dynamically changes during a display of the frame loop.

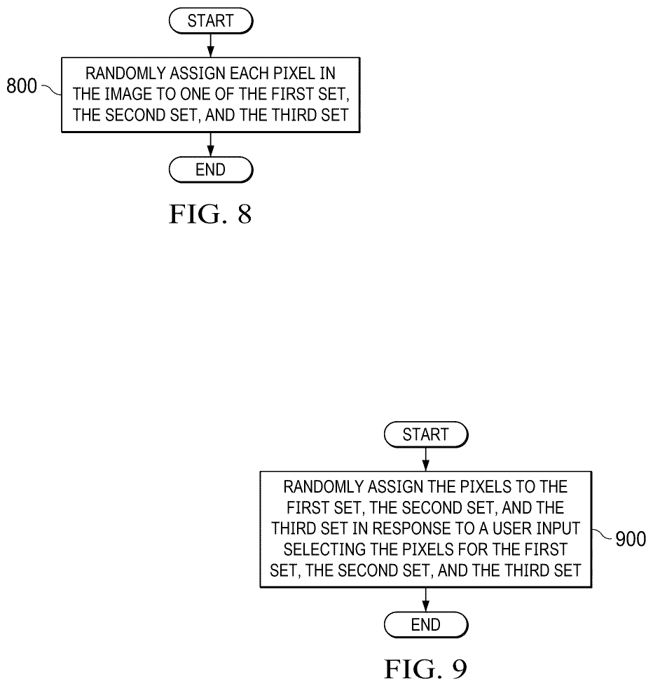

Next in FIG. 8, a flowchart of a process for assigning pixels to sets is depicted in accordance with an illustrative embodiment. The process in this flowchart is an example of an implementation for step 502 in FIG. 5.

The process randomly assigns each pixel in the image to one of the first set, the second set, and the third set (step 800). The process terminates thereafter.

Turning now to FIG. 9, a flowchart of a process for assigning pixels to sets is depicted in accordance with an illustrative embodiment. The process in this flowchart is an example of an implementation for step 502 in FIG. 5.

The process randomly assigns the pixels to the first set, the second set, and the third set in response to a user input selecting the pixels for the first set, the second set, and the third set (step 900). The process terminates thereafter.

The flowcharts and block diagrams in the different depicted embodiments illustrate the architecture, functionality, and operation of some possible implementations of apparatuses and methods in an illustrative embodiment. In this regard, each block in the flowcharts or block diagrams may represent at least one of a module, a segment, a function, or a portion of an operation or step. For example, one or more of the blocks can be implemented as program instructions, hardware, or a combination of the program instructions and hardware. When implemented in hardware, the hardware may, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession can be performed substantially concurrently, or the blocks may sometimes be performed in the reverse order, depending upon the functionality involved. Also, other blocks can be added in addition to the illustrated blocks in a flowchart or block diagram.

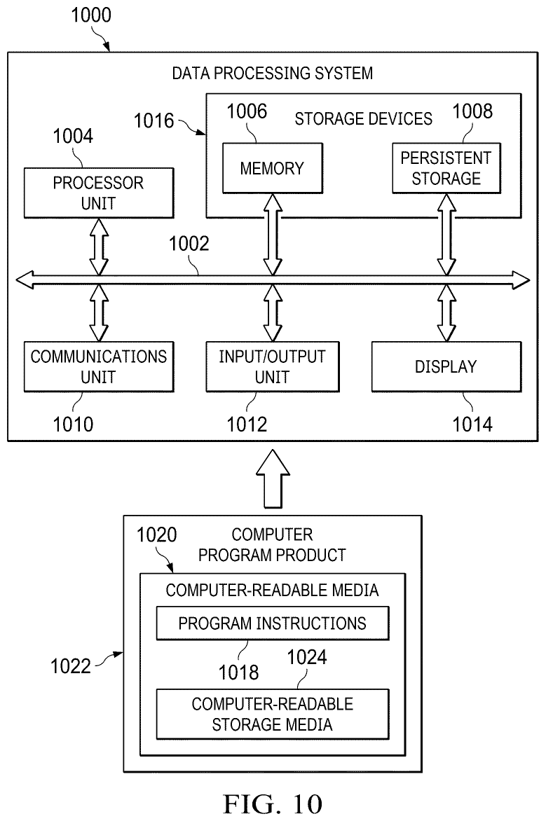

Turning now to FIG. 10, a block diagram of a data processing system is depicted in accordance with an illustrative embodiment. Data processing system 1000 can be used to implement computers and computing devices in computing environment 100 in FIG. 1. Data processing system 1000 can also be used to implement computer system 212 in FIG. 2. In this illustrative example, data processing system 1000 includes communications framework 1002, which provides communications between processor unit 1004, memory 1006, persistent storage 1008, communications unit 1010, input/output (I/O) unit 1012, and display 1014. In this example, communications framework 1002 takes the form of a bus system.

Processor unit 1004 serves to execute instructions for software that can be loaded into memory 1006. Processor unit 1004 includes one or more processors. For example, processor unit 1004 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1004 can be implemented using one or more heterogeneous processor systems in which a main processor is present with secondary processors on a single chip. As another illustrative example, processor unit 1004 can be a symmetric multi-processor system containing multiple processors of the same type on a single chip.

Memory 1006 and persistent storage 1008 are examples of storage devices 1016. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1016 may also be referred to as computer-readable storage devices in these illustrative examples. Memory 1006, in these examples, can be, for example, a random-access memory or any other suitable volatile or non-volatile storage device. Persistent storage 1008 may take various forms, depending on the particular implementation.

For example, persistent storage 1008 may contain one or more components or devices. For example, persistent storage 1008 can be a hard drive, a solid-state drive (SSD), a flash memory, a rewritable optical disk, a rewritable magnetic tape, or some combination of the above. The media used by persistent storage 1008 also can be removable. For example, a removable hard drive can be used for persistent storage 1008.

Communications unit 1010, in these illustrative examples, provides for communications with other data processing systems or devices. In these illustrative examples, communications unit 1010 is a network interface card.

Input/output unit 1012 allows for input and output of data with other devices that can be connected to data processing system 1000. For example, input/output unit 1012 may provide a connection for user input through at least one of a keyboard, a mouse, or some other suitable input device. Further, input/output unit 1012 may send output to a printer. Display 1014 provides a mechanism to display information to a user.

Instructions for at least one of the operating system, applications, or programs can be located in storage devices 1016, which are in communication with processor unit 1004 through communications framework 1002. The processes of the different embodiments can be performed by processor unit 1004 using computer-implemented instructions, which may be located in a memory, such as memory 1006.

These instructions are referred to as program instructions, computer usable program instructions, or computer-readable program instructions that can be read and executed by a processor in processor unit 1004. The program instructions in the different embodiments can be embodied on different physical or computer-readable storage media, such as memory 1006 or persistent storage 1008.

Program instructions 1018 are located in a functional form on computer-readable media 1020 that is selectively removable and can be loaded onto or transferred to data processing system 1000 for execution by processor unit 1004. Program instructions 1018 and computer-readable media 1020 form computer program product 1022 in these illustrative examples. In the illustrative example, computer-readable media 1020 is computer-readable storage media 1024.

Computer-readable storage media 1024 is a physical or tangible storage device used to store program instructions 1018 rather than a medium that propagates or transmits program instructions 1018. Computer-readable storage media 1024, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1018 can be transferred to data processing system 1000 using a computer-readable signal media. The computer-readable signal media are signals and can be, for example, a propagated data signal containing program instructions 1018. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media” 1020 can be singular or plural. For example, program instructions 1018 can be located in computer-readable media 1020 in the form of a single storage device or system. In another example, program instructions 1018 can be located in computer-readable media 1020 that is distributed in multiple data processing systems. In other words, some instructions in program instructions 1018 can be located in one data processing system while other instructions in program instructions 1018 can be located in one data processing system. For example, a portion of program instructions 1018 can be located in computer-readable media 1020 in a server computer while another portion of program instructions 1018 can be located in computer-readable media 1020 located in a set of client computers.

The different components illustrated for data processing system 1000 are not meant to provide architectural limitations to the manner in which different embodiments can be implemented. In some illustrative examples, one or more of the components may be incorporated in or otherwise form a portion of another component. For example, memory 1006, or portions thereof, may be incorporated in processor unit 1004 in some illustrative examples. In other examples, more than one processor unit can be present. The different illustrative embodiments can be implemented in a data processing system including components in addition to or in place of those illustrated for data processing system 1000. Other components shown in FIG. 10 can be varied from the illustrative examples shown. The different embodiments can be implemented using any hardware device or system capable of running program instructions 1018.

Thus, illustrative examples provide a computer implemented method, computer system, and computer program product for securing slides for display. In one example, a method secures a slide. Content in the slide is converted to an image comprising pixels. Each pixel is assigned to one of a first set, a second set, and a third set. Three frames are generated using the first set, the second set, and the third set. A red filter, a green filter, and a blue filter are alternatingly applied to the first set, the second set, and the third set in each of the three frames. A frame rate is set for the three frames. The frame rate enables the three frames for the image to be visible to a human eye. A frame loop comprising the three frames is created with the first set, the second set, and the third set. The slide is saved with the frame loop as the content for the slide.

Thus, with the use of filters and the frequency rate, frequency modulation occurs during the display of the slide in a manner that avoids or reduces the chance that the slide will be captured in a photograph or screenshot. Any photograph or screenshot will be heavily pixelated with color distortion. As a result, this type of distortion in a photograph or screenshot indicates that unauthorized copying or capturing of the slide has occurred.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration, but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A method for securing a slide, the method comprising:
converting content in the slide to an image comprising pixels;
assigning each pixel in the image to one of a first set, a second set, and a third set;
generating three frames using the first set, the second set, and the third set in which a red filter, a green filter, and a blue filter are alternatingly applied to the first set, the second set, and the third set in each of the three frames;
setting a frame rate for the three frames, wherein the frame rate enables the three frames for the image to be visible to a human eye;
creating a frame loop comprising the three frames with the first set, the second set, and the third set; and
saving the slide with the frame loop as the content for the slide.

2. The method of claim 1 further comprising:
displaying the frame loop during a display of the slide, wherein the slide with the frame loop is secured with frequency modulation.

3. The method of claim 1, setting the frame rate comprises:
setting the frame rate within a range of frame rates from a minimum frame rate to a maximum frame rate, wherein the range of frame rates produces images that are visible to the human eye.

4. The method of claim 3, wherein the frame rate comprises a number of frame rates in the range of frame rates that is randomly selected.

5. The method of claim 3, wherein the frame rate is for the frame loop and the frame rate for the frame loop dynamically changes during a display of the frame loop.

6. The method of claim 1, wherein assigning each pixel comprises:
randomly assigning each pixel in the image to one of the first set, the second set, and the third set.

7. The method of claim 1, wherein assigning each pixel comprises:
assigning the pixels to the first set, the second set, and the third set in response to a user input selecting the pixels for the first set, the second set, and the third set.

8. A computer system comprising:
a processor set;
a set of one or more computer-readable storage media; and
program instructions, collectively stored in the set of one or more storage media to cause the processor set to perform operations comprising:
converting content in a slide to an image comprising pixels;
assigning each pixel in the image to one of a first set, a second set, and a third set;
generating three frames using the first set, the second set, and the third set in which a red filter, a green filter, and a blue filter are alternatingly applied to the first set, the second set, and the third set in each of the three frames;
setting a frame rate for the three frames, wherein the frame rate enables the three frames for the image to be visible to a human eye;
creating a frame loop comprising the three frames with the first set, the second set, and the third set; and
saving the slide with the frame loop as the content for the slide.

9. The computer system of claim 8 wherein the operations further comprise:
displaying the frame loop during a display of the slide, wherein the slide with the frame loop is secured with frequency modulation.

10. The computer system of claim 8, setting the frame rate comprises:
setting the frame rate within a range of frame rates from a minimum frame rate to a maximum frame rate, wherein the range of frame rates produces images that are visible to the human eye.

11. The computer system of claim 10, wherein the frame rate comprises a number of frame rates in the range of frame rates that is randomly selected.

12. The computer system of claim 10, wherein the frame rate is for the frame loop and the frame rate for the frame loop dynamically changes during a display of the frame loop.

13. The computer system of claim 8, wherein assigning each pixel comprises:
randomly assigning each pixel in the image to one of the first set, the second set, and the third set.

14. The computer system of claim 8, wherein assigning each pixel comprises:
assigning the pixels to the first set, the second set, and the third set in response to a user input selecting the pixels for the first set, the second set, and the third set.

15. A computer program product for securing a slide, the computer program product comprising:
a set of one or more computer-readable storage media; and
program instructions stored on the set of one or more storage media to perform operations comprising:
converting content in the slide to an image comprising pixels;
assigning each pixel in the image to one of a first set, a second set, and a third set;
generating three frames using the first set, the second set, and the third set in which a red filter, a green filter, and a blue filter are alternatingly applied to the first set, the second set, and the third set in each of the three frames;
setting a frame rate for the three frames, wherein the frame rate enables the three frames for the image to be visible to a human eye;
creating a frame loop comprising the three frames with the first set, the second set, and the third set; and
saving the slide with the frame loop as the content for the slide.

16. The computer program product of claim 15 further comprising:
displaying the frame loop during a display of the slide, wherein the slide with the frame loop is secured with frequency modulation.

17. The computer program product of claim 15, setting the frame rate comprises:
setting the frame rate within a range of frame rates from a minimum frame rate to a maximum frame rate, wherein the range of frame rates produces images that are visible to the human eye.

18. The computer program product of claim 17, wherein the frame rate comprises a number of frame rates in the range of frame rates that is randomly selected.

19. The computer program product of claim 17, wherein the frame rate is for the frame loop and the frame rate for the frame loop dynamically changes during a display of the frame loop.

20. The computer program product of claim 15, wherein assigning each pixel comprises:
randomly assigning each pixel in the image to one of the first set, the second set, and the third set.
